(19) United States
(12) Patent Application Publication
(10) Pub. No.: US 2008/0271153 A1
(43) Pub. Date: Oct. 30, 2008

(54) Method and Apparatus for Handling of Content that includes a Mix of CCI Segments

(75) Inventors: Petr Peterka, San Diego, CA (US); Alexander Medvinsky, San Diego, CA (US); Paul Moroney, Olivenhain, CA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/950,698

(22) Filed: Dec. 5, 2007

Related U.S. Application Data
(60) Provisional application No. 60/914,435, filed on Apr. 27, 2007.

(51) Int. Cl. G06F 21/00

(52) U.S. Cl. 726/26

(57) ABSTRACT

A process is provided. The process stores, on a first device, each segment of a set of content having corresponding copy control information. Further, the process receives, from a second device, a request for a copy of the set of content. In addition, the process analyzes a list of the copy control information associated with each segment of the set of content. The process also establishes a restriction indicator, based on the request for the copy of the set of content, for one or more segments of the set of content having a corresponding copy control information value. Finally, the process provides to the second device, the content, the list of copy control information, and the restriction indicator for the one or more segments.

### RELATED APPLICATIONS

This application claims priority to U.S. Provisional Application Ser. No. 60/914,435 entitled “Handling of Content with a Mix of CCI Segments Including Copy-No-More Content,” filed on Apr. 27, 2007, the content of which is incorporated herein by reference in its entirety.

### BACKGROUND

1. Field

This disclosure generally relates to the field of audio/visual content. More particularly, the disclosure relates to the management of rights associated with audio/visual content.

2. General Background

A recording device such as a Digital Video Recorder (“DVR”) records real-time content coming from sources such as cable, satellite, or broadband sources. The content generally has copy control information (“CCI”) and possibly the rights associated with it.

Commercial content is usually marked by CCI to indicate one or more restrictions associated with the content, e.g., whether a copy of the content can or cannot be made. A recording of such content may include segments with different CCI values. For example, a movie may be marked as copy-once while commercials may be marked as copy freely. Another example may be a recording that includes an extra portion at the beginning and/or the end of the intended content to be recorded to ensure that the full content is recorded. Alternatively, a user requests a time-based recording of broadcast multimedia content that happens to span multiple broadcast programs with different CCI. As a result, the recording may have different sets of content before and/or after the intended content with different CCI for each set.

Copy-once content is usually marked as copy-no-more after the first copy is made. Accordingly, a request to make a copy of copy-no-more content is rejected. Under current configurations, if a device, e.g., a destination device, requests a set of content recorded on another device, e.g., a DVR, that has some segments marked as copy-freely and some segments marked as copy-no-more, the segments cannot easily be separated out so that only the copy-freely segments are provided to the destination device. As a result, the entire set of content may not be copied, to ensure that the destination device does not obtain access to the copy-no-more content even though it should have access to the copy-freely content.

### SUMMARY

In one aspect of the disclosure, a process is provided. The process stores, on a first device, each segment of a set of content having corresponding copy control information. Further, the process receives, from a second device, a request for a copy of the set of content. In addition, the process analyzes a list of the copy control information associated with each segment of the set of content. The process also establishes a restriction indicator, based on the request for the copy of the set of content, for one or more segments of the set of content having a corresponding copy control information value. Finally, the process provides to the second device, the content, the list of copy control information, and the restriction indicator for the one or more segments.

In another aspect of the disclosure, another process is provided. The process requests content from a first device. Further, the process receives, at a second device, the content, a list of copy control information, and a restriction indicator corresponding to one or more segments of the content having a corresponding copy control information value. In addition, the process analyses the restriction indicator corresponding to the one or more segments of the content prior to playback of the segment. Finally, the process prevents decryption and playback of the one or more segments of content if the restriction indicator indicates playback should not be allowed.

In yet another aspect of the disclosure, another process is provided. The process requests content from a first device. Further, the process receives, at a second device, the content and a list of copy control information. In addition, the process copies the content to a storage medium. The process also analyzes the list of copy control information. Further, the process establishes a restriction indicator for one or more segments of the set of content having a corresponding copy control information value. Finally, the process prevents decryption and playback of the one or more segments of content if the restriction indicator indicates playback should not be allowed.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates the interaction between a first device and a second device.

FIG. 2 illustrates a process that may be utilized by the first device to send restricted segments of content to the second device.

FIG. 3 illustrates a process that may be utilized by the second device to receive restricted segments of content from the first device.

FIG. 4 illustrates a system that may be utilized to implement the process shown in FIG. 2 and the process shown in FIG. 3.

FIG. 5 illustrates a block diagram of a station or system that provides handles content with a mix of CCI segments.

### DETAILED DESCRIPTION

A method and apparatus are disclosed that handle content with a mix of CCI segments. The mix of CCI segments includes at least one restricted segment. In one embodiment, the restricted segment is marked copy-no-more. Further, the mix of CCI segments may contain one or more unrestricted segments. For instance, in addition to a copy-no-more segment, the content may include a copy-freely segment. In one embodiment, if a first device stores the content having the mix of CCI segments, a second device receives a copy of the content with the mix of CCI segments along with a restriction indicator. For example, the restriction indicator may be a bit that indicates the second device is not allowed to play the copy-no-more content. As a result, the second device is able to play the content corresponding to the unrestricted CCI segments, e.g., the copy-freely segments, and is unable to play the content corresponding to the restricted CCI segments, e.g., the copy-no-more content.

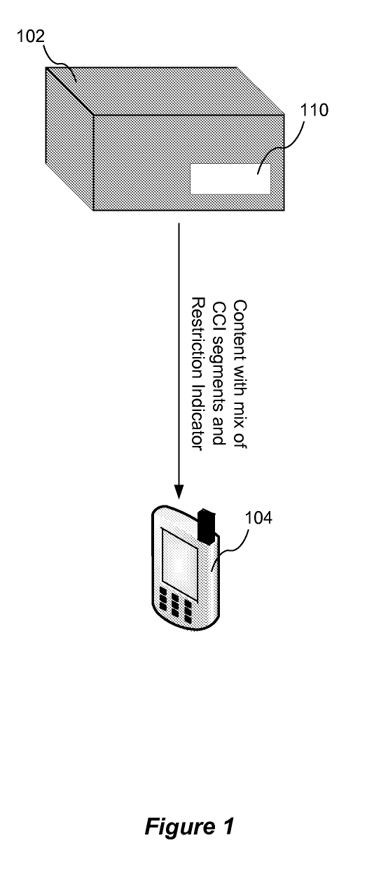

FIG. 1 illustrates the interaction between a first device 102 and a second device 104. Examples of the first device 102 can include, but are not limited to, a Digital Video Recorder (“DVR”), portable media player (“PMP”) mp3/mp4 player, mobile phone, personal digital assistant (“PDA”), and the like. The second device 104 can be a similar or different device than the first device 102. Further, the second device 104 can communicated with the first device 102. Accordingly, the second device 104 can be selected from any of the examples provided with respect to the first device 102. After the first device 102 receives content with one or more segments having a CCI restriction of copy-once, the first device 102 makes a copy of the content for storage on a hard drive. Accordingly, the CCI restriction on the one or more segments changes to copy-no-more. Further, the content may also have unrestricted segments having a CCI restriction of copy-freely. If the second device 104 requests the content, the first device 102 provides the content with restricted and unrestricted segments along with a restriction indicator. In one embodiment, the restriction indicator provides the restriction that should be associated with the restricted segment. For instance, copy-no-more, a remaining number of copies that are allowed after the copy to the destination device 102, etc. are restrictions. When the second device 104 sees the restriction indicator, the second device 104 prevents decryption and rendering for the restricted segment, and reinitiates decryption for unrestricted segments.

In another embodiment, the restricted and unrestricted segments may be utilized to indicate the video quality of the content. For instance, High-Definition (“HD”) segments may be restricted where as Standard-Definition (“SD”) segments may be unrestricted (“SD”). If there is a mix of HD and SD content, e.g., the end of an HD television show combined with an SD television show, the second device 104can still receive the content along with the restriction indicator, but only be allowed to play the SD content. The restriction indicator may be utilized to indicate that certain devices are not allowed to play the HD content. For instance, the second device 104 may not be able to play the HD content because it is not as trusted as other DVRs, which would be allowed to play the HD content.

The first device 102 may communicate with the second device 104 through a variety of different mechanisms. For instance, the first device 102 may communicate with the second device 104 through a network such as a home network. Further, the first device 102 may also communicate with the second device 104 through a transmission line. The first device 102 may also communicate with the second device 104 by having a removable memory module storing the content removed from the first device 102 and inserted into the second device 104.

Further, the methodology described herein is not limited to the interaction between a second device 104 and the first device 102. Various other devices may utilize the same methodology when interacting with the first device 102. For instance, another DVR or other devices within the home network may utilize the methodology.

The restriction indicator can be any type of indicator. For instance, the restriction indicator can be an extra bit sent with the content, a flag, etc. Alternatively, the restriction indicator can be supplemental information sent during key negotiation between the two devices.

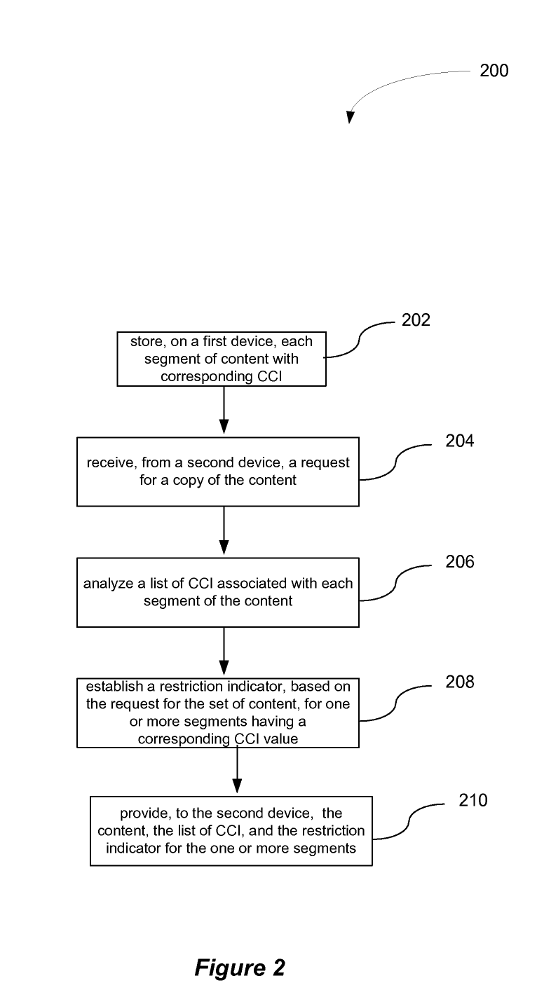

FIG. 2 illustrates a process 200 that may be utilized by the first device 102 to send restricted segments of content to the second device 104. At a process block 202, the process 200 stores, on a first device, each segment of content with corresponding CCI. Further, at a process block 204, the process 200 receives, from a second device, a request for a copy of the content. In addition, at a process block 206, the process 200 analyzes a list of the CCI associated with each segment of the set of content. At a process block 208, the process 200 establishes a restriction indicator, based on the request for the copy of the set of content, for one or more segments of the set of content having a corresponding CCI value. Finally, at a process block 210, the process 200 provides, to the second device, the content, the list of copy control information, and the restriction indicator for the one or more segments.

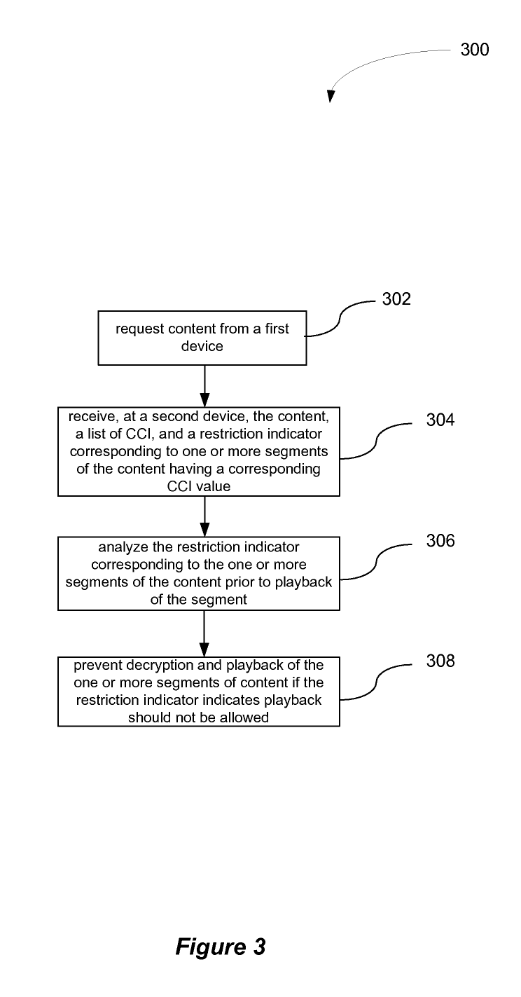

FIG. 3 illustrates a process 300 that may be utilized by the second device 104 to receive restricted segments of content from the first device 102. At a process block 302, the process 300 requests content from a first device. Further, at a process block 304, the process 300 receives, at a second device, the content, a list of CCI, and a restriction indicator corresponding to one or more segments of the content having a corresponding copy control information value. In addition, at a process block 306, the process 300 analyzes the restriction indicator corresponding to the one or more segments of the content prior to playback of the segment. Finally, the process 300 prevents decryption and playback of the one or more segments of content if the restriction indicator indicates playback should not be allowed.

In an alternative embodiment, the process 300 may be implemented such that the second device 104 establishes the restriction indicator rather than receiving the restriction indicator from the first device 102. The second device 104 may request content from the first device 102. Further, the second device 104 may receive the content and a list of CCI. In addition, the second device 104 may copy the content to a storage medium. The second device 104 may also analyze the list of CCI. Further, the second device 104 may establish a restriction indicator for one or more segments of the set of content having a corresponding copy control information value. Finally, the second device 104 may prevent decryption and playback of the one or more segments of content if the restriction indicator indicates playback should not be allowed.

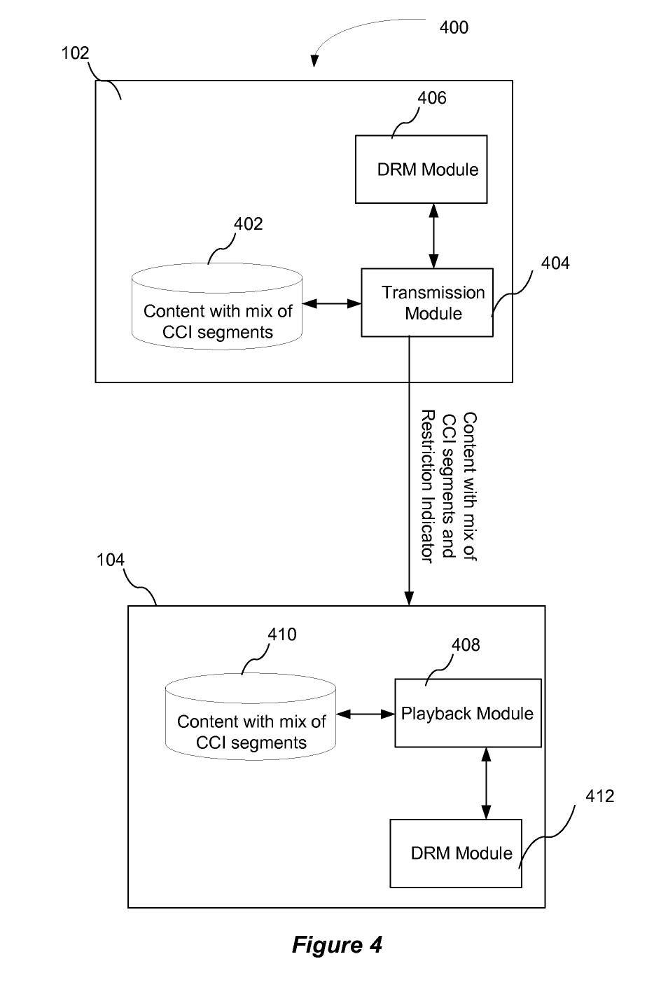

FIG. 4 illustrates a system 400 that may be utilized to implement the process 200 shown in FIG. 2 and the process 300 shown in FIG. 3. The system includes the first device 102 and the second device 104. The first device 102 includes a storage 402 that stores the content with a mix of CCI segments. Further, the first device 102 includes a transmission module 404 that obtains the segments for transmission. Prior to proceeding with the transmission module 404 communicates with a DRM module 406, which examines the CCI and sets the restriction indicator. The transmission module then transmits the content with the mix of CCI segments and the restriction indicator to the second device 104. At the second device 104, a storage 410 is utilized to store the content with the mix of CCI segments. Further, a playback module 408 obtains the content and communicates with a DRM module 412, which examines the restriction indicator to determine if the playback module 408 is allowed to decrypt and playback a particular segment. Accordingly, if the playback module 408 is allowed to decrypt and playback the particular segment, the playback module 408 proceeds with decryption and playback. In one embodiment, if the playback module 408 is now allowed to decrypt and playback the particular segment, the playback module 408 skips to a next segment and communicates with the DRM module 412 to determine if the next segment is allowed to be decrypted and played back.

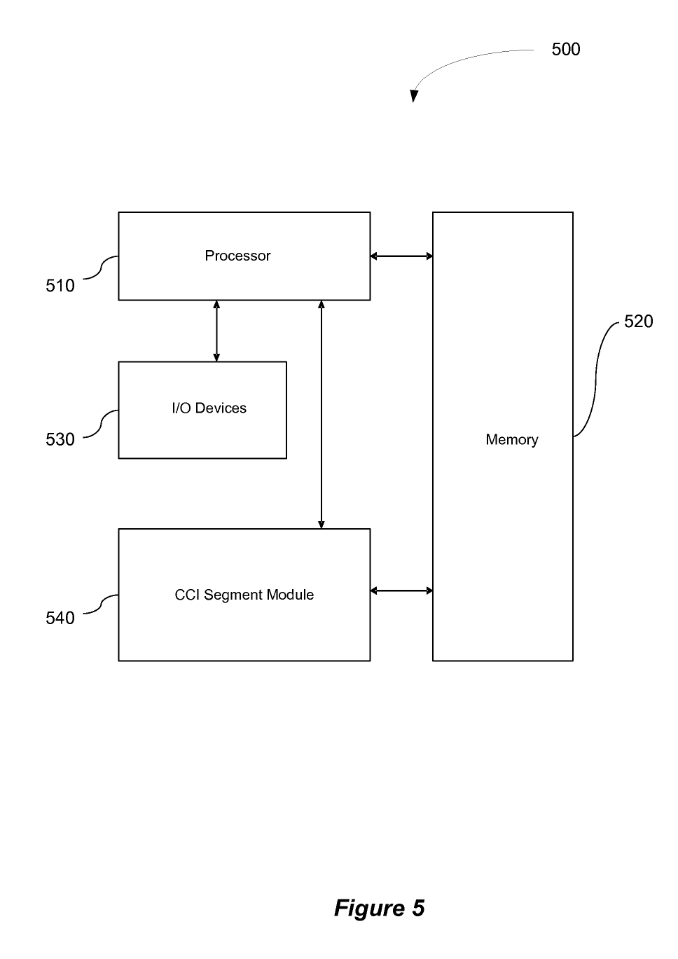

FIG. 5 illustrates a block diagram of a station or system 500 that provides handles content with a mix of CCI segments. In one embodiment, the station or system 500 is implemented using a general purpose computer or any other hardware equivalents. Thus, the station or system 500 comprises a processor 510, a memory 520, e.g., random access memory (“RAM”) and/or read only memory (ROM), a CCI segment module 540, which can either be the transmission module 404 or the playback module 408 depending on whether the first device or second device is utilized, and various input/output devices 530, (e.g., e.g., audio/video outputs and audio/video inputs, storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands)). The transmission module 404 may include one or more processors, and/or corresponding code.

It should be understood that the CCI segment module 540 may be implemented as one or more physical devices that are coupled to the processor 510. Alternatively, the CCI segment module 540 may be represented by one or more software applications (or even a combination of software and hardware, e.g., using application specific integrated circuits (ASIC)), where the software is loaded from a storage medium, (e.g., a magnetic or optical drive or diskette) and operated by the processor in the memory 520 of the computer. As such, the CCI segment module 540 (including associated data structures) of the present disclosure may be stored on a computer readable medium, e.g., RAM memory, magnetic or optical drive or diskette and the like.

It is understood that the restriction indicator approach described herein may also be applied in other types of systems. Those skilled in the art will appreciate that the various adaptations and modifications of the embodiments of this method and apparatus may be configured without departing from the scope and spirit of the present method and system. Such adaptations and modifications may include a restriction indicator that is not represented by a single bit or flag. Other such adaptations and modifications may include more complex copy protection rules that are associated with a restriction indicator. Therefore, it is to be understood that, within the scope of the appended claims, the present method and apparatus may be practiced other than as specifically described herein.

We claim:

1. A method comprising:
storing, on a first device, each segment of a set of content having corresponding copy control information;
receiving, from a second device, a request for a copy of the set of content;
analyzing a list of the copy control information associated with each segment of the set of content;
establishing a restriction indicator, based on the request for the copy of the set of content, for one or more segments of the set of content having a corresponding copy control information value; and
providing to the second device, the content, the list of copy control information, and the restriction indicator for the one or more segments.

2. The method of claim 1, wherein the one or more segments are grouped according to copy control information.

3. The method of claim 1, wherein the restriction indicator is a control bit that is appended to rights information.

4. The method of claim 1, wherein the restriction indicator is a do not play flag.

5. The method of claim 1, wherein the copy information includes a copy-no-more rule.

6. The method of claim 1, wherein the restriction indicator is associated with one or more High-Definition video segments.

7. The method of claim 1, wherein the first device is a digital video recorder.

8. A method comprising:
requesting content from a first device;
receiving, at a second device, the content, a list of copy control information, and a restriction indicator corresponding to one or more segments of the content having a corresponding copy control information value;
analyzing the restriction indicator corresponding to the one or more segments of the content prior to playback of the segment; and
preventing decryption and playback of the one or more segments of content if the restriction indicator indicates playback should not be allowed.

9. The method of claim 8, further comprising skipping to a next segment if decryption and playback of the segment is prevented.

10. The method of claim 8, wherein the one or more segments are grouped according to copy control information.

11. The method of claim 8, wherein the restriction indicator is a control bit that is appended to rights information.

12. The method of claim 8, wherein the restriction indicator is a do not play flag.

13. The method of claim 8, wherein the copy information includes a copy-no-more rule.

14. The method of claim 8, wherein the restriction indicator is associated with one or more High-Definition video segments.

15. A method comprising:
requesting content from a first device;
receiving, at a second device, the content and a list of copy control information;
copying the content to a storage medium;
analyzing the list of copy control information;
establishing a restriction indicator for one or more segments of the set of content having a corresponding copy control information value; and
preventing decryption and playback of the one or more segments of content if the restriction indicator indicates playback should not be allowed.

16. The method of claim 15, further comprising skipping to a next segment if decryption and playback of the segment is prevented.

17. The method of claim 15, wherein the one or more segments are grouped according to copy control information.

18. The method of claim 15, wherein the restriction indicator is a control bit that is appended to rights information.

19. The method of claim 15, wherein the restriction indicator is a do not play flag.

20. The method of claim 15, wherein the copy information includes a copy-no-more rule.
